(19) United States
(12) Patent Application Publication
(10) Pub. No.: US 2023/0209242 A1
(43) Pub. Date: Jun. 29, 2023

(54) NECK-HANGING TYPE HEADPHONE

(71) Applicant: Shenzhen Antexin Technology Co., Ltd., Shenzhen (CN)

(72) Inventors: Mingqiang Xu, Shenzhen (CN); Yingjian Zhang, Shenzhen (CN)

(21) Appl. No.: 17/584,437

(22) Filed: Jan. 26, 2022

(30) Foreign Application Priority Data
Dec. 29, 2021 (CN) 202111646508.5

(51) Int. Cl. H04R 1/10

(52) U.S. Cl. CPC H04R 1/105; H04R 1/1033; H04R 2201/10

(57) ABSTRACT

The disclosure provides a neck-hanging type headphone. The neck-hanging type headphone includes a headphone body, wherein the headphone body is detachably connected to one end of an ear-hanging connector, a first neck-hanging piece or a second neck-hanging piece or a third neck-hanging piece or a fourth neck-hanging piece is arranged at the other end of the ear-hanging connector through a fixing mechanism, and the first neck-hanging piece, the second neck-hanging piece, the third neck-hanging piece and the fourth neck-hanging piece are detachably connected to the ear-hanging connector. According to the solution, the corresponding first neck-hanging piece or second neck-hanging piece or third neck-hanging piece or fourth neck-hanging piece may be selected for wearing according to different situation requirements. The neck-hanging type headphone is applicable to different scenarios and requirements, and has the advantages of wide applicability, convenience in use and the like.

### CROSS REFERENCE TO RELATED APPLICATIONS

The present application claims the benefit of Chinese Patent Application No. 202111646508.5 filed on Dec. 29, 2021, the contents of which are incorporated herein by reference in their entirety.

### FIELD

The present disclosure belongs to the technical field of headphones, and particularly relates to a neck-hanging type headphone.

### BACKGROUND

The non-in-ear type headphone on the market at present has a single wearing mode, which is also true for the neck-hanging type headphone. It is impossible to switch the headphone shapes according to different requirements to realize different neck-hanging wearing modes, so that customers need to buy different types of headphones in different usage scenarios. It can be seen that existing neck-hanging headphones have a single wearing mode and have the problems of inconvenience in use and influence on the use experience of customers.

Therefore, the prior art has shortcomings and needs to be improved.

### SUMMARY

An objective of the present disclosure is to overcome the shortcomings in the prior art and provide a neck-hanging type headphone.

The present disclosure is implemented as follows: a neck-hanging type headphone includes a headphone body, wherein the headphone body is detachably connected to one end of an ear-hanging connector, a first neck-hanging piece or a second neck-hanging piece or a third neck-hanging piece or a fourth neck-hanging piece is arranged at the other end of the ear-hanging connector through a fixing mechanism, and the first neck-hanging piece, the second neck-hanging piece, the third neck-hanging piece and the fourth neck-hanging piece are detachably connected to the ear-hanging connector.

Further, the ear-hanging connector, the first neck-hanging piece and the second neck-hanging piece are made of tr90.

Further, the fixing mechanism includes a connecting groove and connecting heads embedded in the connecting groove, wherein the connecting groove is formed in the other end of the ear-hanging connector, and the connecting heads are arranged on the neck-hanging pieces.

Further, the first neck-hanging piece is a strip-shaped object matched with a lower end of the human neck, and the connecting heads are arranged at two ends of the first neck-hanging piece.

Further, the second neck-hanging piece is a strip-shaped object matched with an upper end of the human neck, and the connecting heads are arranged at two ends of the second neck-hanging piece.

Further, the third neck-hanging piece includes a neck ring, two ends of the neck ring extend to form connecting wires, and the connecting head is arranged on each of the connecting wires.

Further, the fourth neck-hanging piece includes an electrical adapter cable and a headphone cable, the connecting heads are arranged at two ends of the electrical adapter cable, one end of the headphone cable is connected to the electrical adapter cable, and a power connector connected to a broadcasting device is arranged at the other end of the headphone cable.

Further, the connecting head includes an extending piece, a clamping piece which gradually widens from top to bottom is arranged at a top end of the extending piece, and a bottom area of the clamping piece is greater than a surface area of the extending piece.

Further, a mounting groove structure is formed on the headphone body, and a matched protruded structure corresponding to the mounting groove structure is formed on the ear-hanging connector.

Further, a groove body of the mounting groove structure is wide at a bottom and narrow at a top.

According to the neck-hanging type headphone provided by the present disclosure, the corresponding first neck-hanging piece or second neck-hanging piece or third neck-hanging piece or fourth neck-hanging piece may be selected to cooperate with the headphone body for use according to different situation requirements, so that the problem that an existing neck-hanging type headphone has a single usage mode is solved. The neck-hanging type headphone is applicable to different scenarios and requirements, and has the advantages of wide applicability, convenience in use and the like.

### BRIEF DESCRIPTION OF THE DRAWINGS

To describe the technical solutions in the embodiments of the present disclosure or in the prior art more clearly, the accompanying drawings required to describe the embodiments or the prior art are briefly described below. Obviously, the accompanying drawings described below are only some embodiments of the present disclosure, those of ordinary skill in the art can obtain other drawings based on the accompanying drawings without creative effort.

The following drawings are only intended to schematically illustrate and explain the present disclosure, and do not limit the scope of the present disclosure.

FIG. 1 is a schematic diagram of cooperation of a headphone body and an ear-hanging connector according to the present disclosure.

FIG. 2 is an exploded view of cooperation of the headphone body and the ear-hanging connector according to the present disclosure.

FIG. 3 is a schematic diagram of cooperation of the headphone body, the ear-hanging connector and connecting heads according to the present disclosure.

FIG. 4 is a schematic diagram of cooperation of the headphone body, the ear-hanging connector and a first neck-hanging piece according to the present disclosure.

FIG. 5 is a schematic diagram of cooperation of the headphone body, the ear-hanging connector and a second neck-hanging piece according to the present disclosure.

FIG. 6 is a schematic diagram of cooperation of the headphone body, the ear-hanging connector and a third neck-hanging piece according to the present disclosure.

FIG. 7 is a schematic diagram of cooperation of the headphone body, the ear-hanging connector and a fourth neck-hanging piece according to the present disclosure,

### DESCRIPTION OF REFERENCE NUMERALS

1. Headphone body; 11. Mounting groove structure; 12. Charging terminal; 2. Ear-hanging connector; 21. Protruded structure; 3. First neck-hanging piece; 4. Second neck-hanging piece; 5. Third neck-hanging piece; 51. Neck ring; 52. connecting wire; 6. Fourth neck-hanging piece; 61. Electrical adapter cable; 62. Headphone cable; 63. Power connector; 7. Connecting head; 71. Extending piece; 72. Clamping piece.

### DETAILED DESCRIPTION OF THE EMBODIMENTS

To make the objectives, technical solutions, and advantages of the present disclosure clearer, the present disclosure will be further described below in detail in combination with the accompanying drawings and embodiments. It should be understood that the specific embodiments described herein are only used to explain the present disclosure and are not used to limit the present disclosure.

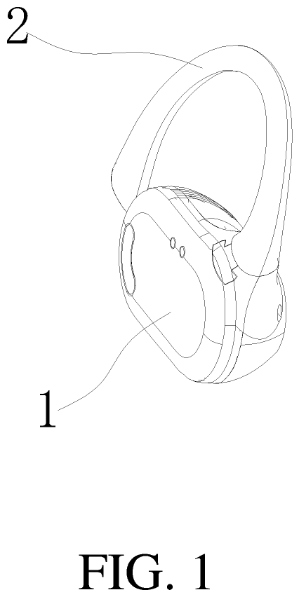

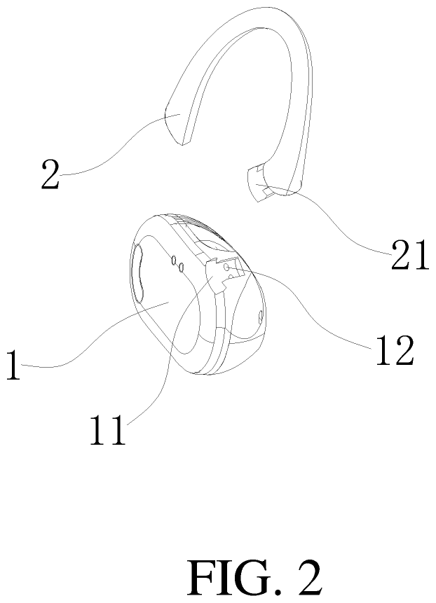

Referring to FIG. 1 to FIG. 7, a neck-hanging type headphone disclosed by the present disclosure includes: a headphone body 1, wherein the headphone body 1 is detachably connected to one end of an ear-hanging connector 2, the ear-hanging connector 2 is of a bending shape matched with the outer contour of the human ear, the ear-hanging connector 2 is made of tr90, and the tr90 is a high molecular material with a memory function, so that deformation of the ear-hanging connector 2 during use can be avoided, it is unnecessary for a user to adjust the shape of the ear-hanging connector 2 during each use, and the use feeling is improved; in addition, the tr90 has low friction coefficient, high toughness, collision resistance and wear resistance, so that the use comfort can be further improved, and the user can wear the ear-hanging connector 2 for a longer time. Preferably, a mounting groove structure 11 is formed on the headphone body 1, a matched protruded structure 21 corresponding to the mounting groove structure 11 is formed on the ear-hanging connector 2, and a groove body of the mounting groove structure 11 is wide at a bottom and narrow at a top. By the adoption of the groove body with such a shape, mounting and assembling will be more stable. The shape of the protruded structure 21 is matched with the shape of the mounting groove structure 11, and specifically, the protruded structure 21 has a boss structure which is wide at a bottom and narrow at a top. During mounting and use, the protruded structure 21 can be embedded into the mounting groove structure 11 from a side surface to realize the assembling process and is not liable to fall off. Further, the headphone body 1 is provided with a charging terminal 12, and the charging terminal 12 is arranged on a bottom surface of the mounting groove structure 11. In the solution, the charging terminal 12 may also be arranged at other positions of the headphone body 1, for example, the charging terminal is arranged on a side surface of the headphone body 1, or the headphone body 1 adopts wireless charging (magnetic suction wireless charging) to realize charging, which is also within the protection scope of the present disclosure.

A first neck-hanging piece 3 or a second neck-hanging piece 4 or a third neck-hanging piece 5 or a fourth neck-hanging piece 6 is arranged at the other end of the ear-hanging connector 2 through a fixing mechanism, and the first neck-hanging piece 3, the second neck-hanging piece 4, the third neck-hanging piece 5 and the fourth neck-hanging piece 6 are detachably connected to the ear-hanging connector 2. The fixing mechanism includes a connecting groove (not shown in the figure) and connecting heads 7 embedded into the connecting groove, the connecting groove is formed in the other end of the ear-hanging connector 2, the connecting heads 7 are arranged on the neck-hanging pieces, and the connecting heads 7 are embedded into the connecting groove to realize connection between the whole ear-hanging connector 2 and the first neck-hanging piece 3, or the second neck-hanging piece 4 or the third neck-hanging piece 5 or the fourth neck-hanging piece 6. The connecting head 7 specifically includes an extending piece 71, a clamping piece 72 which gradually widens from top to bottom is arranged at a top end of the extending piece 71, and a bottom area of the clamping piece 72 is greater than a surface area of the extending piece 71. The clamping piece 72 extends into the connecting groove from a narrow end. With the gradual widening of the clamping piece 72, the clamping piece 72 can be tightly connected to the connecting groove, so that connection between the whole connecting head 7 and the connecting groove is stabilized.

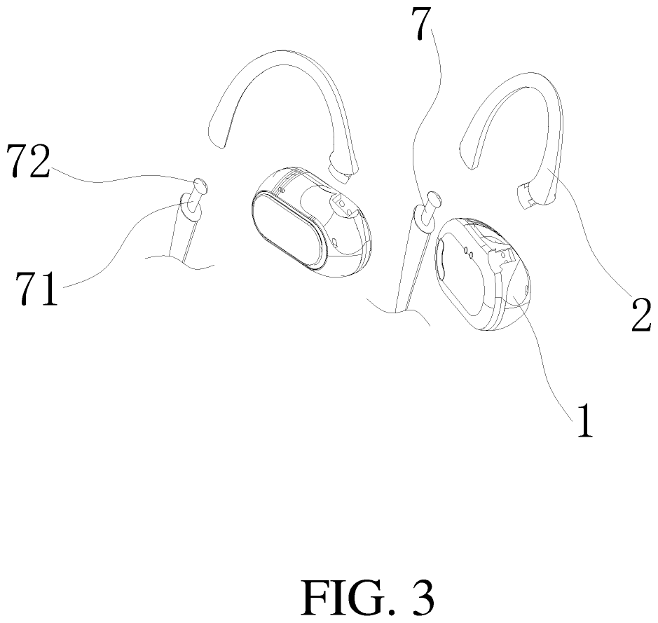

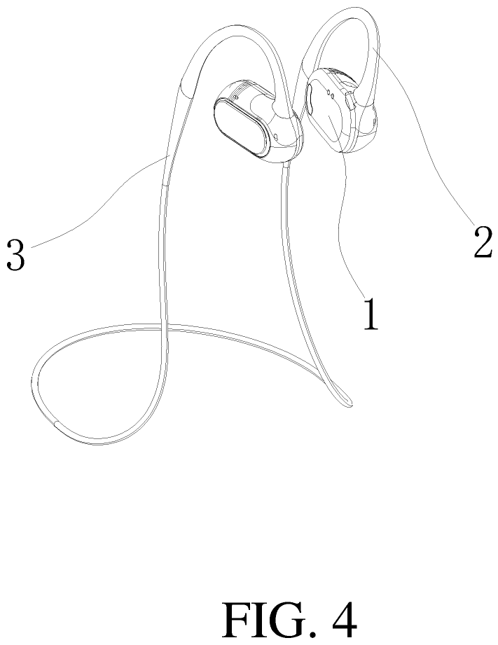

As shown in FIG. 3 to FIG. 4, the first neck-hanging piece 3 is a strip-shaped object matched with a lower end of the human neck, and the connecting heads 7 are arranged at two ends of the first neck-hanging piece 3. When the ear-hanging connector 2 is matched with the first neck-hanging piece 3, the first neck-hanging piece 3 forms a semi-circular shape to abut against the lower end of the human neck, so that one pair of the headphone bodies 1 can be effectively prevented from being removed from the human body.

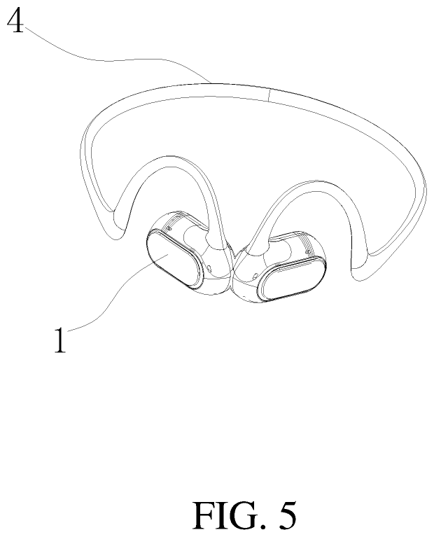

As shown in FIG. 5, the second neck-hanging piece 4 is a strip-shaped object matched with an upper end of the human neck, and the connecting heads 7 are arranged at two ends of the second neck-hanging piece 4. When the ear-hanging connector 2 is matched with the second neck-hanging piece 4, the second neck-hanging piece 4 forms a semi-circular shape, is located at the upper end of the human neck, and cannot be in contact with the human shoulder or cannot waggle back and forth at the neck during use, so that the pressure on the should and neck is reduced, and the use comfort is improved. As another embodiment of the second neck-hanging piece 4, the second neck-hanging piece 4 may be formed integrally with the ear-hanging connector 2, so that production materials are saved and cost is reduced.

Further, in conclusion, other combined assemblies are not arranged in the first neck-hanging piece 3 and the second neck-hanging piece 4, the first neck-hanging piece 3 and the second neck-hanging piece 4 are in direct contact with the human neck, and in order to further improve the use comfort, the neck-hanging piece 3 and the second neck-hanging piece 4 are both made of tr90.

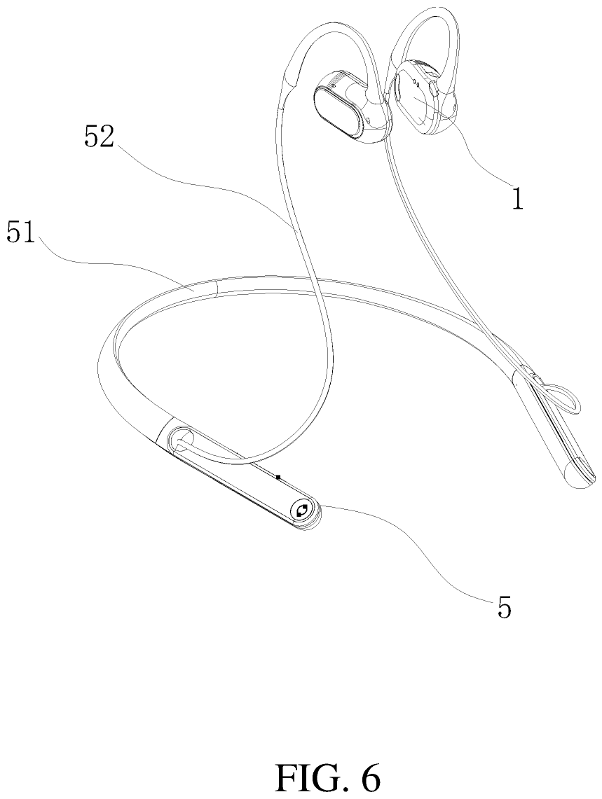

As shown in FIG. 6, the third neck-hanging piece 5 includes a neck ring 51, wherein two ends of the neck ring 51 extend to form connecting wires 52, each connecting wire 52 is provided with the connecting head 7, and the neck ring 51 may be provided with a control button for controlling operation of the headphone body 1, such as a volume button and a power button, which facilitates that a user controls the headphone body 1.

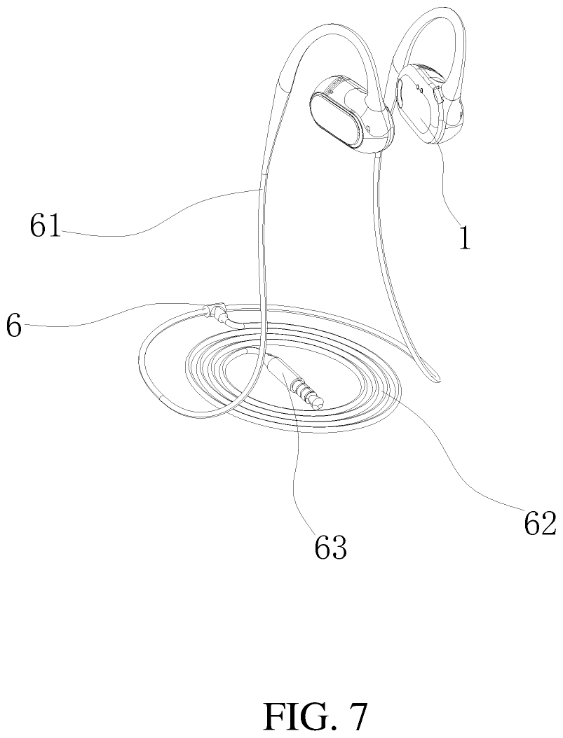

As shown in FIG. 7, the fourth neck-hanging piece 6 includes an electrical adapter cable 61 and a headphone cable 62, the connecting heads 7 are arranged at two ends of the electrical adapter cable 61, one end of the headphone cable 62 is connected to the electrical adapter cable 61, and a power connector 63 connected to a broadcasting device is arranged at the other end of the headphone cable 62. When the battery capacity of the headphone body 1 is exhausted, the fourth neck-hanging piece 6 is used. Specifically, the power connector 63 is connected to the broadcasting device, and the headphone body 1 is equivalent to a wired headphone for sustainable use.

In conclusion, according to the solution, the corresponding neck-hanging piece may be selected according to different situation requirements, that is, the headphone body 1, the ear-hanging connector 2 and the first neck-hanging piece 3/second neck-hanging piece 4/third neck-hanging piece 5/fourth neck-hanging piece 6 are connected in sequence to switch various wearing modes, so that the problem that the existing neck-hanging headphone has a single use mode is solved. On the other hand, through direct cooperation with the headphone body 1 and the ear-hanging connector 2, the neck-hanging type headphone may serve as a wireless ear-hanging headphone, is applicable to different scenarios and requirements, has the advantages of high applicability and convenience in use, and is conducive to achieving a good use experience.

The above are only preferred embodiments of the present disclosure and are not used to limit the present disclosure. Any modification, equivalent replacement or improvement made within the spirit and principle of the present disclosure should be included in the protection scope of the present disclosure.

What is claimed is:

1. A neck-hanging type headphone, comprising a headphone body (1), wherein the headphone body (1) is detachably connected to one end of an ear-hanging connector (2), a first neck-hanging piece (3) or a second neck-hanging piece (4) or a third neck-hanging piece (5) or a fourth neck-hanging piece (6) is arranged at the other end of the ear-hanging connector (2) through a fixing mechanism, and the first neck-hanging piece (3), the second neck-hanging piece (4), the third neck-hanging piece (5) and the fourth neck-hanging piece (6) are detachably connected to the ear-hanging connector (2).

2. The neck-hanging type headphone according to claim 1, wherein the ear-hanging connector (2), the first neck-hanging piece (3) and the second neck-hanging piece (4) are made of tr90.

3. The neck-hanging type headphone according to claim 2, wherein the fixing mechanism comprises a connecting groove and connecting heads (7) embedded in the connecting groove, the connecting groove is formed in the other end of the ear-hanging connector (2), and the connecting heads (7) are arranged on the neck-hanging piece.

4. The neck-hanging type headphone according to claim 3, wherein the first neck-hanging piece (3) is a strip-shaped object matched with a lower end of the human neck, and the connecting heads (7) are arranged at two ends of the first neck-hanging piece (3).

5. The neck-hanging type headphone according to claim 3, wherein the second neck-hanging piece (4) is a strip-shaped object matched with an upper end of the human neck, and the connecting heads (7) are arranged at two ends of the second neck-hanging piece (4).

6. The neck-hanging type headphone according to claim 3, wherein the third neck-hanging piece (5) comprises a neck ring (51), two ends of the neck ring (51) extend to form connecting wires (52), and the connecting head (7) is arranged on each of the connecting wires (52).

7. The neck-hanging type headphone according to claim 3, wherein the fourth neck-hanging piece (6) comprises an electrical adapter cable (61) and a headphone cable (62), the connecting heads (7) are arranged at two ends of the electrical adapter cable (61), one end of the headphone cable (62) is connected to the electrical adapter cable (61), and a power connector (63) connected to a broadcasting device is arranged at the other end of the headphone cable (62).

8. The neck-hanging type headphone according to claim 3, wherein the connecting head (7) comprises an extending piece (71), a clamping piece (72) which gradually widens from top to bottom is arranged at a top end of the extending piece (71), and a bottom area of the clamping piece (72) is greater than a surface area of the extending piece (71).

9. The neck-hanging type headphone according to claim 1, wherein a mounting groove structure (11) is formed on the headphone body (1), and a matched protruded structure (21) corresponding to the mounting groove structure (11) is formed on the ear-hanging connector (2).

10. The neck-hanging type headphone according to claim 9, wherein a groove body of the mounting groove structure (11) is wide at a bottom and narrow at a top.
